(19) United States
(12) Patent Application Publication
(10) Pub. No.: US 2010/0312780 A1
(43) Pub. Date: Dec. 9, 2010

(54) SYSTEM AND METHOD FOR DELIVERING PUBLICATION CONTENT TO READER DEVICES USING MIXED MODE TRANSMISSION

(76) Inventors: Vincent LE CHEVALIER, San Jose, CA (US); John RIVLIN, Palo Alto, CA (US); Brady DUGA, Carlsbad, CA (US); Garth CONBOY, LaJolla, CA (US); William LESHNER, San Diego, CA (US); Ruze RICHARDS, Holmdel, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/481,365

(22) Filed: Jun. 9, 2009

(51) Int. Cl. G06F 17/30; G06F 17/00

(52) U.S. Cl. 707/759; 715/234; 707/770; 707/803; 707/802; 707/769; 707/812

(57) ABSTRACT

A system for and method of delivering publication content to one or more reader devices using mixed mode transmission is presented. The system and method may include segmenting, using a computing apparatus, the publication content into a plurality of publication content components. The system and method may also include generating, using a computing apparatus, master publication content that comprises a reference to each publication content component and indicates a structure of the publication content. The system and method may further include multi-casting, to the one or more reader devices, the master publication content and the plurality of publication content components via a network.

### BACKGROUND INFORMATION

Generally, many mobile devices maintain bidirectional communication with one or more communication towers (e.g., cellular towers) using several uni-cast communication sessions. Such uni-cast communication sessions, however, utilize a substantial amount of the bandwidth available for a wireless service provider. In many cases, bidirectional communication is not necessary for successful communication between the one or more communication towers and the mobile devices.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating interconnections among components of an embodiment;

FIG. 2 is a schematic diagram illustrating exemplary modules of a publication content system of an embodiment;

FIG. 3 is a schematic diagram illustrating exemplary modules of a reader device of an embodiment;

FIG. 4 is a flowchart illustrating an exemplary operation of an embodiment;

FIG. 5 is a block diagram illustrating publication content segmented into one or more publication content components and arranged in accordance with master publication content of an embodiment;

FIG. 6 is a diagram illustrating exemplary categories of publication content of an embodiment;

FIG. 7A is a block diagram illustrating exemplary publication content segmented according to a category of publication content of an embodiment;

FIG. 7B is another block diagram illustrating exemplary publication content segmented according to a category of publication content of an embodiment;

FIG. 7C is another block diagram illustrating exemplary publication content segmented according to a category of publication content of an embodiment; and

FIG. 8 is a schematic diagram illustrating an exemplary operation of an embodiment.

### DETAILED DESCRIPTION OF PREFERRED EMBODIMENTS

Efficient delivery of publication content to multiple subscribing reader devices (e.g., reader devices associated with users that have subscribed to receive the publication content) may be realized using multi-cast transmission to transmit at least a portion of the publication content and uni-cast transmission to transmit a remaining portion of the publication content. Publication content may include electronic media information that is periodically distributed to an audience (e.g., an electronic news feed). For example, publication content may include an electronic version of a daily newspaper (e.g., the electronic version of the Connecticut Post newspaper). In another example, publication content may include an electronic version of a monthly magazine (e.g., the electronic version of the Cosmopolitan magazine). In yet another example, publication content may include an electronic version of an up-to-date breaking news source (e.g., the electronic version of Hearst News Service's breaking news).

A publication content system may periodically deliver publication content to multiple subscribing reader devices using multi-cast transmission, uni-cast transmission, or a combination of both. Prior to transmission, the publication content system may segment the publication content into one or more publication content components and generate master publication content that references one or more publication content components and indicates a structure of the one or more publication content components.

In one embodiment, the publication content system may segment the publication content into one or more publication content components that include any, or a combination, of one or more graphic images, one or more sections of text, one or more audio clips, one or more video clips, and one or more rich media elements. The publication content system may also segment the publication content into one or more publication content components by segmenting the publication content into one or more sections that fall on page boundaries.

In one embodiment, the publication content system may generate master publication content that references one or more identifiers associated with one or more publication content components. The master publication content may also indicate a structure of one or more publication content components for display on the multiple subscribing reader devices.

The publication content system may multi-cast any, or a combination, of one or more publication content components and the master publication content to the multiple subscribing reader devices in accordance with a multi-cast transmission schedule using a data network. If, for example, a subscribing reader device fails to receive any, or a combination, of one or more publication content components and the master publication content, the publication content system may uni-cast any, or a combination, of one or more publication content components and the master publication content to the subscribing reader device using a data network.

Once a subscribing reader device has received the one or more publication content components and the master publication content from the publication content system, the subscribing reader device may display the one or more publication content components to a user in accordance with the structure indicated by the master publication content.

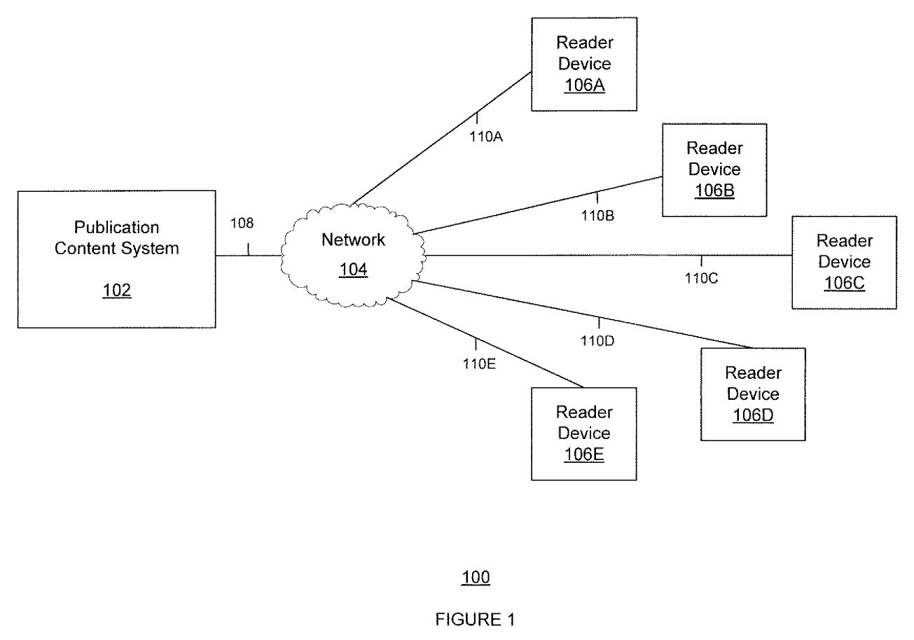

FIG. 1 is a schematic diagram illustrating interconnections among components of an embodiment. As illustrated, data network 104 may communicatively couple publication content system 102 to multiple reader devices, such as: reader device 106A, reader device 106B, reader device 106C, reader device 106D, and reader device 106E. Accordingly, publication content system 102 may transmit data to and receive data from reader device 106A, reader device 106B, reader device 106C, reader device 106D, and reader device 106E using data network 104. For example, publication content system 102 may transmit one or more publication content components and master publication content to reader device 106A, reader device 106B, reader device 106C, reader device 106D, and reader device 106E using data network 104.

The data network 104 may include any, or a combination, of one or more wireless networks, one or more of a local area networks (LANs), one or more wide area networks (WANs), the Internet, one or more cellular networks, one or more satellite networks, and any other network that supports the transmission of data or the reception of data. The data network 104 may utilize one or more protocols of network clients. The data network 104 may also translate to or from other protocols to one or more protocols of network clients. In one embodiment, the data network 104 may include one or more of the networks recited above operating as a stand-alone network or in cooperation with each other. Use of the term network herein is not intended to limit the network to a single network.

The publication content system 102 may be communicatively coupled to one or more reader devices, such as reader devices 106A, 106B, 106C, 106D, 106E via data path 108 and data network 104. The publication content system 102 may include, but is not limited to, a computer device or communications device including, e.g., a personal computer (PC), a workstation, a server, or any other device that is configured to segment publication content into one or more publication content components, generate master publication content, multi-cast one or more publication content component data signals and one or more master publication content data signals to one or more reader devices via data path 108, and uni-cast one or more publication content component data signals and one or more master publication content data signals to one or more reader devices via data path 108. Publication content component data signals may include data associated with one or more publication content components. Master publication content data signals may include data associated with master publication content.

The publication content system 102 may be configured to segment publication content into one or more publication content components that includes any, or a combination, of one or more graphic images, one or more sections of text, one or more audio clips, one or more video clips, and one or more rich media elements. For example, the publication content system 102 may segment first publication content into a first publication content component that includes a section of text (erg., a section of text associated with an article), a second publication content component that includes a graphic image (e.g., a graphic image associated with an advertisement), and a third publication content component that includes an audio clip (e.g., an audio clip associated with article). In another example, the publication content system 102 may segment second publication content into a first publication content component that includes a video clip (e.g., a video clip associated with an advertisement), a second publication content component that includes a section of text (e.g., a section of text associated with an article), and a third publication content component that includes another section of text (e.g., a section of text associated with another article).

The publication content system 102 may also be configured to segment the publication content into one or more publication content components by segmenting the publication content into one or more sections that fall on page boundaries. Each section (e.g., publication content component) may be associated with a category of the publication content, such as: a Front category, a Metropolitan category, a Traffic category, a Nation category, a Politics category, a World category, a Business category, an Editorial category, an Outlook category, an Entertainment category, a Life category, a Lottery category, a Horoscope category, a Sports category, a Tech News category, and a Celebrities category. Accordingly, the publication content system 102 may segment the publication content into one or more publication content components that fall on page boundaries and are associated with a particular category of the publication content.

The publication content system 102 may be configured to generate master publication content that references one or more identifiers associated with one or more publication content components. The publication content system 102 may also be configured to generate master publication content that indicates a structure of one or more publication content components for display on multiple subscribing reader devices, such as reader devices 106A, 106B, 106C, 106D, 106E.

The publication content system 102 may multicast or uni-cast any, or a combination, of one or more publication content components and the master publication content to multiple subscribing reader devices, such as reader devices 106A, 106B, 106C, 106D, 106E, using a data network, such as data network 104. The publication content system 102 is described in further detail below.

In one embodiment, the reader devices 106A, 106B, 106C, 106D, 106E may be communicatively coupled to one or more data networks, such as data network 104. For example, reader device 106A may be configured for communication with data network 104 via data path 110A. In another example, reader device 106B may be configured for communication with data network 104 via data path 110B. In another example, reader device 108C may be configured for communication with data network 104 via data path 110C. In another example, reader device 108D may be configured for communication with data network 104 via data path 110D. In yet another example, reader device 108E may be configured for communication with data network 104 via data path 110E.

The reader devices 106A, 106B, 106C, 106D, 106E may allow the users (e.g., subscribers) to communicate with publication content system 102 via data network 104 and data path 110. For example, users may register with the publication content system 102, subscribe to receive publication content from one or more publication sources, or perform other tasks using the reader devices 106A, 106B, 106C, 106D, 106E,

The reader devices 106A, 106B, 106C, 106D, 106E may be configured to receive any, or a combination, of one or more publication content components and the master publication content from the publication content system 102 via data path 110. In one embodiment, the reader devices 106A, 106B, 106C, 106D, 106E may be configured to receive any, or a combination, of one or more publication content components and the master publication content at one or more scheduled times (e.g., approximate scheduled times) indicated by the multi-cast transmission schedule via data paths 110A, 110B, 110C, 110D, 110E, respectively. If, for example, a reader device fails to receive any, or a combination, of one or more publication content components and the master publication content, the reader device may request re-transmission of any, or a combination, of one or more publication content components and the master publication content via uni-cast transmission by generating and transmitting a uni-cast request to the publication content system 102 using a data path 110.

Once the reader devices 106A, 106B, 106C, 106D, 106E have received the one or more publication content components and the master publication content from the publication content system 102, the reader devices 106A, 1061, 106C, 106D, 106E may display the one or more publication content components to a user (e.g., a subscriber) in accordance with the structure indicated by the master publication content using a display device (e.g., a display screen, a plasma screen, a Liquid Crystal Display (LCD) device). The reader devices 106A, 106B, 106C, 106D, 106E may include those described in U.S. patent application Ser. No. 12/248,331 entitled “Media Display Device And Method Of Operation Thereof,” filed on Oct. 9, 2008, which is incorporated by reference herein in its entirety. The reader devices 106A, 1061, 106C, 106D, 106E are described in further detail below.

One or more data paths disclosed herein may include any device that communicatively couples one or more devices to each other. For example, one or more data paths may include one or more wireless networks or one or more conductive wires (e.g., copper wires).

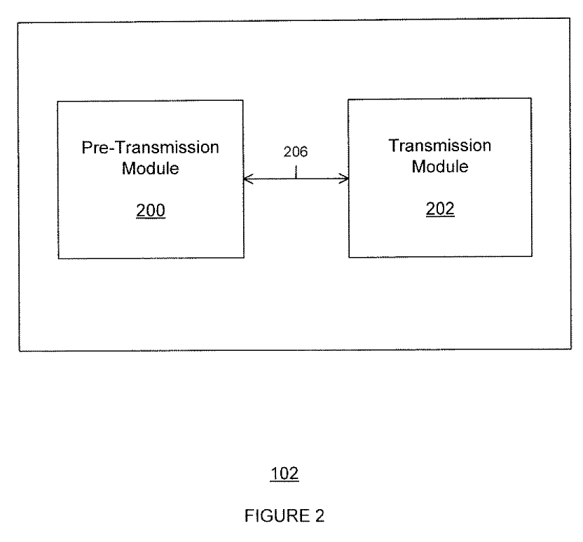

FIG. 2 is a schematic diagram illustrating exemplary modules of a publication content system of an embodiment. The publication content system 102 may include a pre-transmission module 200 and a transmission module 202. It is noted that the modules 200 and 202 are exemplary. The functions of the modules 200 and 202, may be performed at other modules remote or local to the publication content system 102, and the modules 200 and 202 may be combined or separated.

The pre-transmission module 200 may be configured to prepare the publication content for multi-cast transmission, uni-cast transmission, or a combination of both, to multiple subscribing reader devices, such as reader devices 106A, 106B, 106C, 106D, 106E. Accordingly, the pre-transmission module 200 may be configured to perform functions associated with segmenting the publication content and generating master publication content.

The pre-transmission module 200 may include any, or a combination, of software and hardware configured to segment the publication content into one or more publication content components. In one embodiment, the pre-transmission module 200 may be configured to segment the publication content into one or more publication content components that include any, or a combination, of one or more graphic images, one or more sections of text, one or more audio clips, one or more video clips, and one or more rich media elements.

For example, the pre-transmission module 200 may segment publication content (e.g., the electronic version of the Connecticut Post newspaper) into a first publication content component that includes a section of text associated with a first article in the Connecticut Post newspaper, a second publication content component that includes a graphic image associated with an advertisement in the Connecticut Post newspaper, and a third publication content component that includes an audio clip associated with a second article in the Connecticut Post newspaper. In another example, the pre-transmission module 200 may segment additional publication content (e.g., the electronic version of the Cosmopolitan magazine) into a first publication content component that includes a video clip associated with an advertisement in the Cosmopolitan magazine, a second publication content component that includes a section of text associated with a first article in the Cosmopolitan magazine, and a third publication content component that includes an audio clip associated with a second article in the Cosmopolitan magazine.

In one embodiment, the pre-transmission module 200 may be configured to segment publication content into one or more publication content components by segmenting the publication content into one or more sections that fall on page boundaries. The pre-transmission module 200 may segment the publication content into one or more sections by exploiting one or more features of one or more e-book standards, such as one or more features of the Electronic Publication (EPUB) standard supported by the International Digital Publishing Forum (IDPF).

In one embodiment, the pre-transmission module 200 may exploit one or more formatting features of the EPUB standard, such as EPUB's Open Packaging Format (OPE) ability to format multiple electronic documents into an OPF “spine.” An OPF spine may include a formatting feature that identifies the linear reading order of the multiple electronic documents (e.g., publication content). Since each electronic document of the OPF spine is associated with a particular electronic file (e.g., XHTML file) that is separated from another XHTML file by a page break, the pre-transmission module 200 may segment publication content into one or more XHTML files that are separated by page breaks. Accordingly, the pre-transmission module 200 may segment a contiguous collection of pages (e.g., the publication content) into one or more independent segments (e.g., publication content components).

The pre-transmission module 200 may associate each publication content component that is segmented on a page boundary with a category of publication content, such as: a Front category, a Metropolitan category, a Traffic category, a Nation category, a Politics category, a World category, a Business category, an Editorial category, an Outlook category, an Entertainment category, a Life category, a Lottery category, a Horoscope category, a Sports category, a Tech News category, and a Celebrities category. For example, the pre-transmission module 200 may segment publication content (e.g., the electronic version of the Connecticut Post newspaper) into a first publication content component that includes a first page of the Nation section of the Connecticut Post newspaper, a second publication content component that includes a second page of the Nation section of the Connecticut Post newspaper, and a third publication content component that includes a first page of the Traffic section of the Connecticut Post newspaper.

In one embodiment, the pre-transmission module 200 may be configured to receive user input from a user of a reader device, such as reader device 106A, indicating interest in receiving publication content associated with one or more particular categories. Accordingly, the pre-transmission module 200 may deliver the publication content components that are associated with the one or more particular categories to the user's reader device (e.g., reader device 106A).

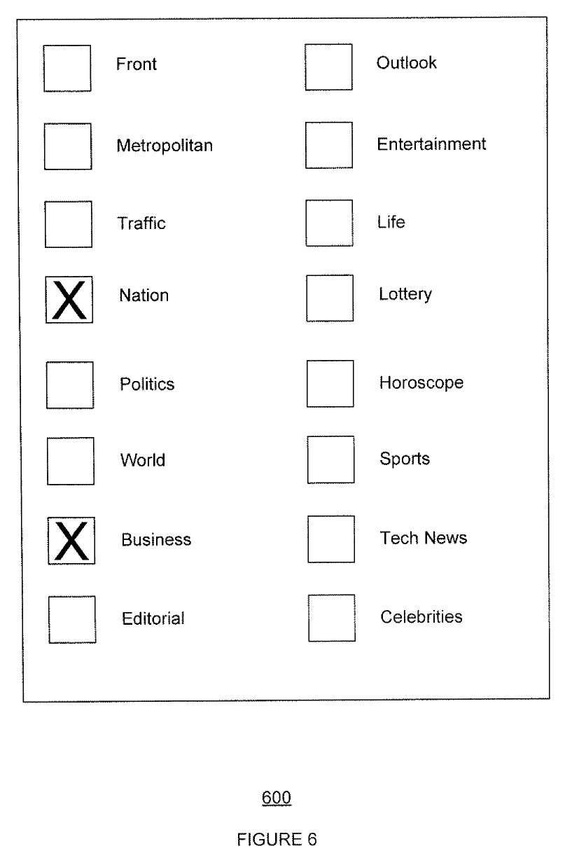

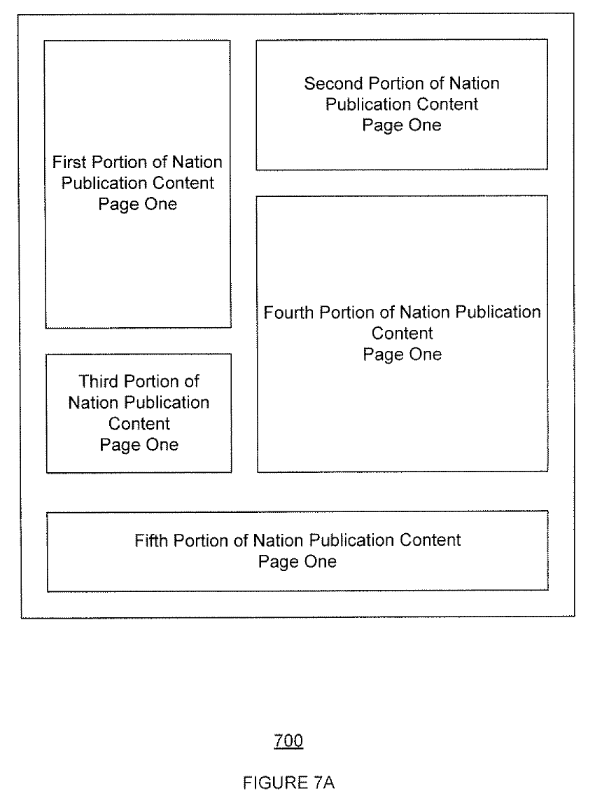

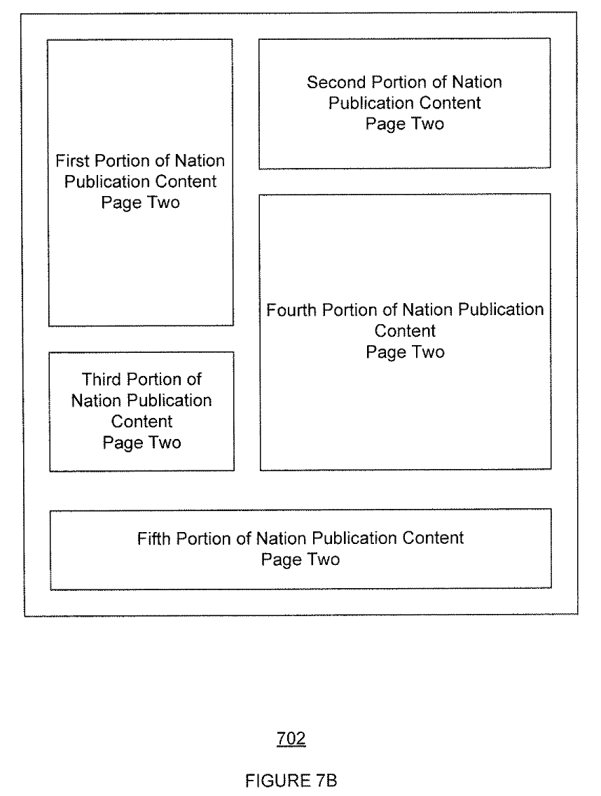

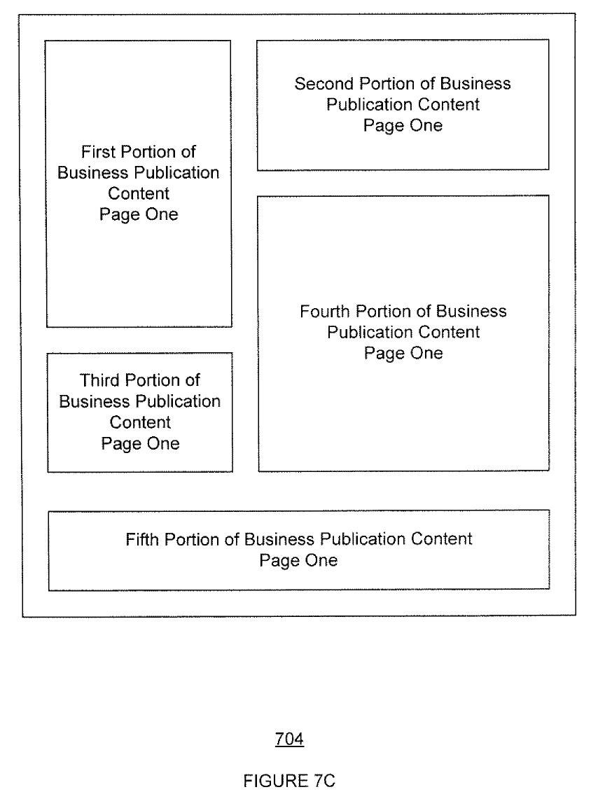

FIG. 6, FIG. 7A, FIG. 7B, and FIG. 7C may illustrate the technique described above. FIG. 6 is a diagram illustrating exemplary categories of publication content of an embodiment. The pre-transmission module 200 of the publication content system 102 may allow one or more users to view a list of one or more categories of publication content 600. Using a user input device (e.g., a keyboard, mouse), the one or more users may select which categories in which they are interested in receiving publication content. As illustrated in FIG. 6, a user may select the Nation category of publication content and the Business category of publication content. Based on the user's selection, the pre-transmission module 200 of the publication content system 102 may output one or more publication content components associated with the Nation category (e.g., Nation pages with Nation publication content) and one or more publication content components associated with the Business category (e.g., Business pages with Business publication content) as illustrated in FIG. 7A, FIG. 7B, and FIG. 7C.

FIG. 7A is a block diagram illustrating exemplary publication content segmented according to a category of publication content of an embodiment. As illustrated in FIG. 7A, the pre-transmission module 200 may deliver a first page 700 associated with the Nation category of publication content that contains Nation publication content based on a user's selection of the Nation category

FIG. 7B is a block diagram illustrating exemplary publication content segmented according to a category of publication content of an embodiment. As illustrated in FIG. 7B, the pre-transmission module 200 may deliver a second page 702 associated with the Nation category of publication content that contains Nation publication content based on a user's selection of the Nation category.

FIG. 7C is a block diagram illustrating exemplary publication content segmented according to a category of publication content of an embodiment. As illustrated in FIG. 7C, the pre-transmission module 200 may deliver a first page 704 associated with the Business category of publication content that contains Business publication content based on a user's selection of the Business category.

Referring again to FIG. 2, the pre-transmission module 200 may be configured to assign a unique identifier to each publication content component such that each publication content component is uniquely identifiable throughout a system. In one embodiment, the pre-transmission module 200 may assign an arbitrary unique number that is derived from a single source (e.g., a random number generator that generates monotonically increasing numbers) to each publication content component. In one embodiment, the pre-transmission module 200 may assign a Globally Unique Identifier (GUID) to each publication content component. In one embodiment, the pre-transmission module 200 may assign a unique identifier that is derived from a Hash function (e.g., SHA-1, Message Digest algorithm 5 (MD5)) performed on the publication content component to each publication content component.

The pre-transmission module 200 may include any, or a combination, of software and hardware configured to generate master publication content that references one or more publication content components. For example, the pre-transmission module 200 may be configured to generate master publication content that references one or more identifiers associated with the one or more publication content components. Accordingly, the master publication content may be used by a reader device to determine whether the one or more publication content components referenced by the master publication content have been received.

The pre-transmission module 200 may also be configured to generate master publication content that indicates a structure of one or more publication content components. In one embodiment, the structure of the one or more publication content components may indicate a display position of the one or more publication content components. Accordingly, the master publication content may be used by a reader device to determine the proper display position of each publication content component associated with the master publication content.

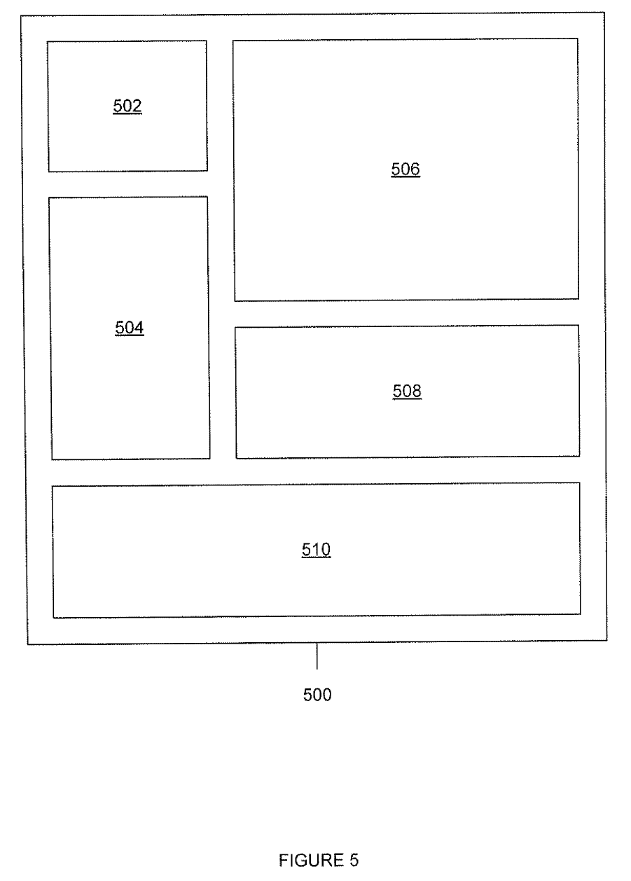

The interaction of one or more publication content components and the master publication content may be illustrated in FIG. 5. FIG. 5 is a block diagram illustrating publication content segmented into one or more publication content components and arranged in accordance with master publication content of an embodiment. As illustrated in FIG. 5, the pre-transmission module 200 may output master publication content 500 that references one or more publication content components, such as publication content components 502, 504, 506, 508, 510. Based on the master publication content's reference to the publication content components 502, 504, 506, 508, 510 and, reader devices, such as reader devices 106A, 106B, 106C, 106D, 106E may determine whether they have received the publication content components referenced by the master publication content. Based on the master publication content's indication of a structure of the publication content components 502, 504, 506, 508, 510, reader devices 106A, 106B, 106C, 106D, 106E may output (e.g., display) the publication content components 502, 504, 506, 508, 510 to one or more users in the proper display position.

Referring again to FIG. 2, the transmission module 202 may be configured to transmit the one or more publication content components and the master publication content to multiple subscribing reader devices, such as reader devices 106A, 106B, 106C, 106D, 106E using multi-cast transmission, uni-cast transmission, or a combination of both. Accordingly, the transmission module 202 may be configured to perform functions associated with multi-casting and uni-casting any, or a combination, of the one or more publication content components and the master publication content to reader devices 106A, 106B, 106C, 106D, 106E.

The transmission module 202 may be configured to multi-cast any, or a combination, of the one or more publication content components and the master publication content to reader devices 106A, 106B, 106C, 106D, 106E in accordance with a multi-cast transmission schedule. A multi-cast transmission schedule may indicate one or more scheduled times (e.g., approximate scheduled times) at which the transmission module 202 may multi-cast any, or a combination, of the one or more publication content components and the master publication content to reader devices 106A, 106B, 106C, 106D, 106E. The transmission module 202 may store the multi-cast transmission schedule at a storage location that is accessible by the reader devices 106A, 106B, 106C, 106D, 106E. Accordingly, a reader device may “listen” at the appropriate scheduled time for the multi-cast of the publication content for which a user has subscribed to receive.

If, for example, a subscribing reader device fails to receive any, or a combination, of one or more publication content components and the master publication content, the reader device may generate and transmit a uni-cast request for one or more of the missing portions of the publication content. In response to the uni-cast request, the transmission module 202 may uni-cast any, or a combination, of one or more publication content components and the master publication content to the subscribing reader device.

Data path 204 may communicatively couple the pre-transmission module 200 and the transmission module 202 to each other. Accordingly, pre-transmission module 200 may transmit data to and receive data from transmission module 202 via data path 204. Likewise, transmission module 202 may transmit data to and receive data from pre-transmission module 200 via data path 204.

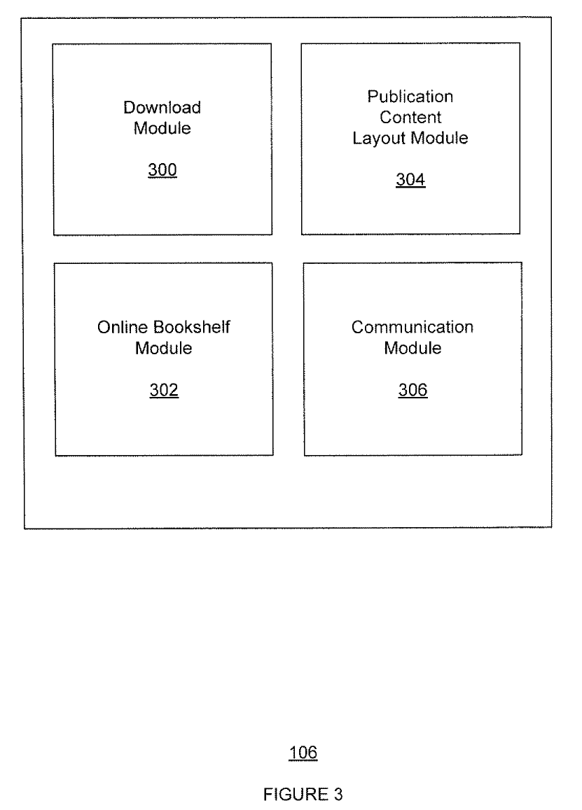

FIG. 3 is a schematic diagram illustrating exemplary modules of a reader device of an embodiment. A reader device 106 may include a download module 300, an online bookshelf module 302, a publication content layout module 304, and a communication module 306. It is noted that the modules 300, 302, 304, and 306 are exemplary. The functions of the modules 300, 302, 304, and 306, may be performed at other modules remote or local to the reader device 106, and the modules 300, 302, 304, and 306 may be combined or separated.

The online bookshelf module 302 may include any, or a combination, of software and hardware configured to periodically (e.g., hourly, daily, weekly) access a particular storage location (e.g., an online bookshelf) on the publication content system 102. In one embodiment, the online bookshelf module 302 may be configured to periodically access the storage location to retrieve information that indicates the publication content that a user of the reader device 106 has subscribed to receive. In one embodiment, the online bookshelf module 302 may be configured to periodically access the storage location to retrieve the multi-cast transmission schedule that indicates one or more scheduled times at which the subscribed publication content will be delivered via multi-cast transmission.

For example, the multi-cast transmission schedule may indicate that subscribed publication content (e.g., the electronic version Connecticut Post newspaper) will be delivered via multi-cast transmission at 6:00 AM every morning. In another example, the multi-cast transmission schedule may indicate that subscribed publication content (e.g., the electronic version of the Cosmopolitan magazine) will be delivered via multi-cast transmission at 6:00 AM on the first day of every month.

At the scheduled times of delivery of the subscribed publication content, the download module 300 may “wake up” and “listen” for the multi-casting of the subscribed publication content. Accordingly, the download module 300 may receive and store (e.g., in a local cache on the reader device 106) any, or a combination, of the one or more publication content components and the master publication content associated with the subscribed publication content via multi-cast transmission.

The publication content layout module 304 may include any, or a combination, of software and hardware configured to determine whether the one or more publication content components and the master publication content have been received from the publication content system. If, for example, the one or more publication content components and the master publication content have been received, the publication content layout module 304 may mark the publication content as complete and output (e.g., display) the one or more publication content components to a user in accordance with the structure indicated by the master publication content using a display device (e.g., a display screen, a plasma screen, a Liquid Crystal Display (LCD)). If, however, the reader device 106 fails to receive any, or a combination, of the one or more publication content components and the master publication content, the communication module 306 may generate and transmit a uni-cast request that requests the publication content system 102 to deliver one or more of the missing portions of the publication content to the reader device 106 via uni-cast transmission.

The publication content system 102 and the reader device 106 may be configured to employ one or more download optimization techniques. In one embodiment, content signatures may be used to indicate which of the one or more publication content components have been received by a reader device 106 and which of the one more publication content components need to be downloaded by the reader device 106.

Since publication content may change frequently (e.g., news publication content changes frequently), the publication content system 102 may frequently deliver updates to the publication content. Accordingly, a reader device 106 may need to download publication modifications frequently. In one embodiment, one or more download optimization techniques may be used to prevent the reader device 106 from unnecessarily downloading publication content that has not been modified.

In such embodiments, the publication content system 102 may perform a hash function on each publication content component of the publication content when the publication content components are generated. The result of each hash function may be stored in an index that is accessible by the reader device 106. Accordingly, a reader device 106 may access the index and compare the results of the hash function associated with the one or more publication content components of the subscribed publication content to the results of the hash function on the one or more publication content components stored on the reader device 106. If the comparison indicates a difference in the values of the results of the two hash functions, the reader device 106 may download the updated publication content. If, however, the comparison does not indicate a difference in the values of the results of the two hash functions, the reader device 106 may refrain from downloading additional publication content.

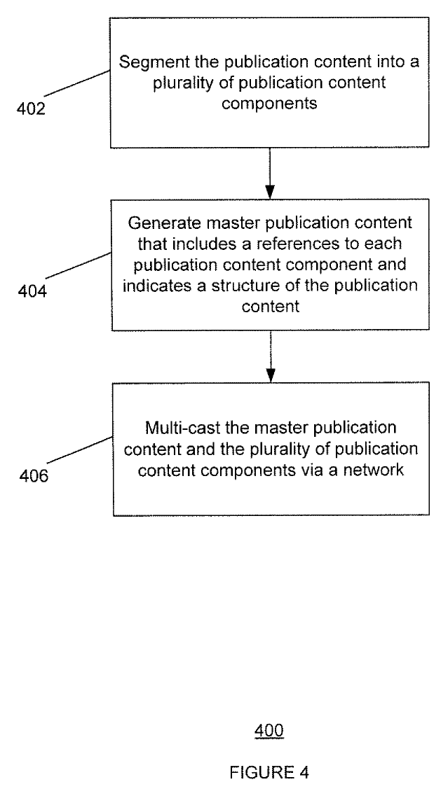

FIG. 4 is a flowchart illustrating an exemplary operation of an embodiment. This exemplary method 400 is provided by way of example, as there are a variety of ways to carry out methods disclosed herein. The method 400 shown in FIG. 4 may be executed or otherwise performed by one or a combination of various systems. The method 400 is described below as carried out by the publication content system 102 shown in FIG. 1 by way of example, and various elements of the publication content system 102 are referenced in explaining the example method of FIG. 4. Each block shown in FIG. 4 represents one or more processes, methods, or subroutines carried out in the exemplary method 400. Referring to FIG. 4, the exemplary method 400 may begin at block 402.

In block 402, the method 400 may include segmenting the publication content into a plurality of publication content components. In one embodiment, the pre-transmission module 200 of the publication content system 102 may segment the publication content into a plurality of publication content components. For example, the pre-transmission module 200 may segment the publication content into a plurality of publication content components that include any, or a combination, of one or more graphic images, one or more sections of text, one or more audio clips, one or more video clips, and one or more rich media elements. In another example, the pre-transmission module 200 may segment the publication content into a plurality of publication content components by segmenting the publication content into a plurality of sections that fall on page boundaries. The method 400 may continue to block 404.

In block 404, the method 400 may include generating master publication content that includes a reference to each publication content component and indicates a structure of the publication content. In one embodiment, the pre-transmission module 200 of the publication content system 102 may generate master publication content that includes a reference to each publication content component and indicates a structure of the publication content. The method 400 may continue to block 406.

In block 406, the method 400 may include multi-casting the master publication content and the plurality of publication content components. In one embodiment, the transmission module 202 of the publication content system 102 may multi-cast the master publication content and the plurality of publication content components to the one or more reader devices using a data network, such as data network 104. The method 400 may then end.

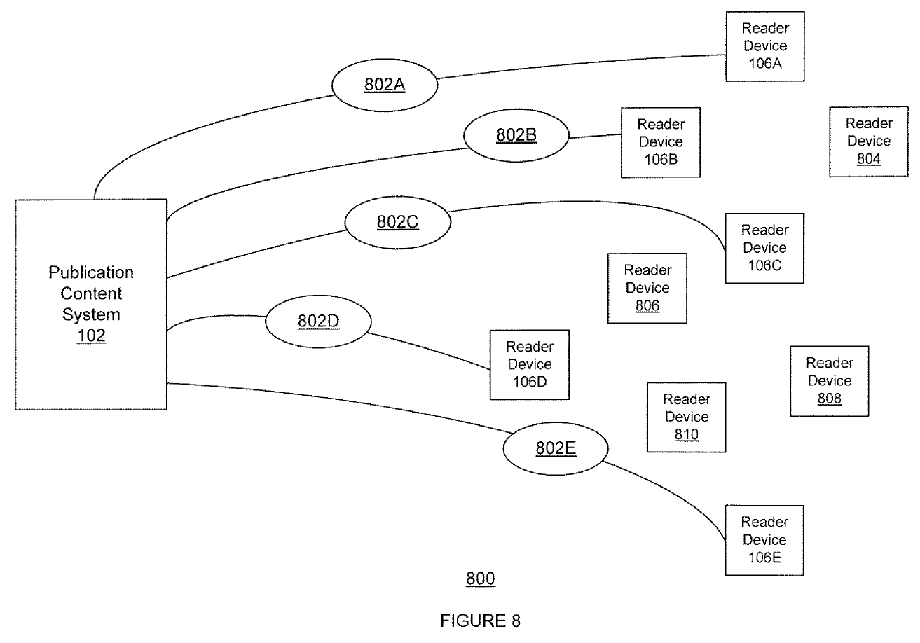

FIG. 8 is a schematic diagram illustrating an exemplary operation of an embodiment. As illustrated in FIG. 8, the publication content system 102 deliver one or more publication content components and the master publication content to one or more subscribing reader devices using multi-cast transmission. For example, the publication content system 102 may deliver content 802A, 802B, 802C, 802D, 802E (e.g., one or more publication content components, master publication content) to one or more subscribing reader devices, such as subscribing reader devices 106A, 106B, 106C, 106D, 106E using multi-cast transmission. Since reader devices 804, 806, 808, 810 are not subscribing reader devices, they may not receive content from the publication content system 102.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for delivering publication content to one or more reader devices using mixed mode transmission, the system comprising:
a pre-transmission computing apparatus configured to segment the publication content into a plurality of publication content components;
the pre-transmission computing apparatus configured to generate master publication content that comprises at least one reference to each publication content component and indicates a structure of the publication content; and
a transmission computing apparatus configured to multi-cast, to the one or more reader devices, the master publication content and the plurality of publication content components via a network.

2. The system of claim 1, wherein the pre-transmission computing apparatus is further configured to segment by segmenting the publication content based on user input data.

3. The system of claim 2, wherein the user input data indicates a user's interest in one or more categories of publication content.

4. The system of claim 3, wherein the one or more categories of publication content comprise at least one of: a Front category, a Metropolitan category, a Traffic category, a Nation category, a Politics category, a World category, a Business category, an Editorial category, an Outlook category, an Entertainment category, a Life category, a Lottery category, a Horoscope category, a Sports category, a Tech News category, and a Celebrities category.

5. The system of claim 1, wherein the pre-transmission computing apparatus is further configured to segment by segmenting the publication content based on one or more page boundaries of the publication content.

6. The system of claim 17 wherein the reference comprises a unique identifier associated with each publication content component.

7. The system of claim 1, wherein the structure of the publication content indicates a display position of each publication content component.

8. The system of claim 1, wherein the transmission module is further configured to multi-cast by multi-casting, to the one or more reader devices, the master publication content and the plurality of publication content components in accordance with a multi-cast transmission schedule.

9. The system of claim 1, wherein the transmission computing apparatus is further configured to uni-cast, to the one or more reader devices, at least one publication content component via the network in response to a uni-cast request from the one or more reader devices.

10. The system of claim I, wherein the transmission computing apparatus is further configured to uni-cast, to the one or more reader devices, the master publication content via the network in response to a uni-cast request from the one or more reader devices.

11. The system of claim 15 wherein each reader device comprises an electronic paper display.

12. A computer-implemented method for delivering publication content to one or more reader devices using mixed mode transmission, the computer-implemented method comprising:
segmenting, using a computing apparatus, the publication content into a plurality of publication content components;
generating, using a computing apparatus, master publication content that comprises a reference to each publication content component and indicates a structure of the publication content; and
multi-casting, to the one or more reader devices, the master publication content and the plurality of publication content components via a network.

13. The computer-implemented method of claim 12, wherein the step of segmenting further comprises segmenting the publication content based on user input data.

14. The computer-implemented method of claim 13, wherein the user input data indicates a user's interest in one or more categories of publication content.

15. The computer-implemented method of claim 14, wherein the one or more categories of publication content comprise at least one of: a Front category, a Metropolitan category, a Traffic category, a Nation category, a Politics category, a World category, a Business category, an Editorial category, an Outlook category, an Entertainment category, a Life category, a Lottery category, a Horoscope category, a Sports category, a Tech News category, and a Celebrities category.

16. The computer-implemented method of claim 12, wherein the step of segmenting further comprises segmenting the publication content based on one or more page boundaries of the publication content.

17. The computer-implemented method of claim 12, wherein the reference comprises a unique identifier associated with each publication content component.

18. The computer-implemented method of claim 12, wherein the structure of the publication content indicates a display position of each publication content component.

19. The computer-implemented method of claim 12, wherein the step of multi-casting further comprises multi-casting, to the one or more reader devices, the master publication content and the plurality of publication content components in accordance with a multi-cast transmission schedule.

20. The computer-implemented method of claim 12, further comprising uni-casting, to the one or more reader devices, at least one publication content component via the network in response to a uni-cast request from the one or more reader devices.

21. The computer-implemented method of claim 12, further comprising uni-casting, to the one or more reader devices, the master publication content via the network in response to a uni-cast request from the one or more reader devices.

22. The computer-implemented method of claim 12, wherein each reader device comprises an electronic paper display.
